(19) United States
(12) Patent Application Publication
(10) Pub. No.: US 2007/0282876 A1
(43) Pub. Date: Dec. 6, 2007

(54) METHOD FOR SERVICE OFFERING COMPARITIVE IT MANAGEMENT ACTIVITY COMPLEXITY BENCHMARKING

(76) Inventors: Yixin Diao, White Plains, NY (US); Robert Filepp, Westport, CT (US); Robert D. Kearney, Yorktown Heights, NY (US); Alexander Keller, New York, NY (US)

Correspondence Address: CAHN & SAMUELS, LLP, 2000 P. STREET, NW, SUITE 200, WASHINGTON, DC, 20036, US

(21) Appl. No.: 11/422,218

(22) Filed: Jun. 5, 2006

(51) Int. Cl. G06F 7/00

(52) U.S. Cl. 707/101

(57) ABSTRACT

The invention broadly and generally provides a database comprising at least one record, the aforesaid at least one record comprising: (a) solution metadata relating to an information technology solution; and (b) evaluation metadata relating to a complexity evaluation of the aforesaid information technology solution.

### FIELD OF THE INVENTION

The present invention relates to the comparative evaluation of information technology (IT) management activities associated with technology solutions and, more particularly, to methods for comparatively and quantitatively evaluating IT management activity complexity associated with technology solutions.

### BACKGROUND OF THE INVENTION

Many purchasers and developers of technology solutions such as computing systems and software, rely on external parties that specialize in service offerings which compare the functionality, performance, return on investment, and reliability of such solutions. Purchasers rely on evaluations from trusted third parties to guide their investment decisions. Similarly developers utilize such evaluations to improve their products, and to properly position them in the marketplace. However no service offerings currently exist that are specifically targeted to comparative quantitative evaluations of the complexity of the information technology (IT) management activities that are associated with such technology solutions.

The complexity of managing technology solutions, for example configuring computing systems, represents a major impediment to efficient, error-free, and cost-effective deployment and management of computing systems of all scales, from handheld devices to desktop personal computers to small-business servers to enterprise-scale and global-scale IT backbones. By way of example, configuring a computing system may encompass any process via which any of the system's structure, component inventory, topology, or operational parameters are persistently modified by a human operator or system administrator.

IT management activities with a high degree of complexity demand human resources to manage that complexity, increasing the total cost of ownership of the computing system. Likewise, complexity increases the amount of time that must be spent interacting with a technology solution to manage it to perform the desired function, again consuming human resources and decreasing efficiency and agility. Finally, increased IT management activity complexity results in errors, as excessive complexity challenges human reasoning and often results in erroneous decisions even by skilled operators.

Because the burdens of IT management activity complexity are so high, it is evident that technology solutions designers, architects, and implementers will seek to reduce such complexity. Likewise, the purchasers, users, and managers of such solutions will seek to assemble solutions which exhibit minimal complexity. In order to do so, it is beneficial to have the ability to quantitatively evaluate the degree of complexity associated with a particular IT management activity. For example, designers, architects, and developers can evaluate the systems they build and optimize them for reduced complexity; purchasers, users, and managers can evaluate prospective purchases for complexity before investing in them. Furthermore, quantitative evaluation of complexity can help computing service providers and outsourcers quantify the amount of human management that will be needed to provide a given service, facilitating more effective evaluation of costs and providing better information for setting price points.

All these scenarios require standardized, representative, accurate, easily-compared quantitative assessments of IT management activity complexity, and suffer for the lack of a way to quantitatively evaluate the complexity of an arbitrary IT management activity.

While the prior art of technology solution evaluation includes systems and method to categorize the complexity of several aspects of technology solutions, the prior art of computing system evaluation includes no system or methods for objectively comparing quantitative evaluations of the complexity of IT management activities. Well-studied technology solution evaluation areas include system performance analysis, software complexity analysis, human-computer interaction analysis, and dependability evaluation.

System performance analysis attempts to compute quantitative measures of the performance of a computer system, considering both hardware and software components. This is a well-established area rich in analysis techniques and systems. However, none of these methodologies and systems for system performance analysis consider IT management-related aspects of the system under evaluation, nor do they collect or analyze IT management-related data. Therefore, system performance analysis provides no insight into the IT management activity complexity of the computing system being evaluated.

Software complexity analysis attempts to compute quantitative measures of the complexity of a piece of software code, considering both the intrinsic complexity of the code, as well as the complexity of creating and maintaining the code. However, processes for software complexity analysis do not collect IT management activity-related statistics or data and therefore provides no insight into the overall complexity of the IT management activities associated with the technology solution.

Human-computer interaction (HCI) analysis attempts to identify interaction problems between human users and computer systems, typically focusing on identifying confusing, error-prone, or inefficient interaction patterns. However, HCI analysis focuses on detecting problems in human-computer interaction rather than performing an objective, quantitative complexity analysis of that interaction. HCI analysis methods are not designed specifically for measuring IT management activity complexity, and typically do not operate on IT management activity-related data. In particular, HCI analysis collects human performance data from observations of many human users, and thus does not collect IT management activity-related data directly from a system under test.

Additionally, HCI analysis typically produces qualitative results suggesting areas for improvement of a particular user interface or interaction pattern and, thus, do not produce quantitative results that evaluate the overall complexity of a system, independent of the particular user interface experience. The Model Human Processor approach to HCI analysis does provide objective, quantitative results; however, these results quantify interaction time for motor-function tasks like moving a mouse or clicking an on-screen button, and thus do not provide complete insight into the overall complexity of IT management activities.

Human-aware dependability evaluation combines aspects of objective, reproducible performance benchmarking with HCI analysis techniques with a focus on configuration-related problems, see, e.g., Brown et al., “Experience with Evaluating Human-Assisted Recovery Processes,” Proceedings of the 2004 International Conference on Dependable Systems and Networks, Los Alamitos, Calif., IEEE, 2004. This approach included a system for measuring configuration quality as performed by human users, but did not measure configuration complexity and did not provide reproducibility or objective measures.

Other related previous work includes U.S. patent application Ser. No. 10/392,800, which deals with estimation of project complexity using a complexity matrix for estimation, and U.S. Pat. No. 6,970,803, which pertains to determining the complexity of a computing environment.

### SUMMARY OF THE INVENTION

The invention broadly and generally provides a database comprising at least one record, the aforesaid at least one record comprising: (a) solution metadata relating to an information technology solution; and (b) evaluation metadata relating to a complexity evaluation of the aforesaid information technology solution. The aforesaid solution metadata may comprise at least one of: (a) an identifier for the aforesaid information technology solution; (b) a description of the purpose of the aforesaid information technology solution; (c) the price of the aforesaid information technology solution; (d) a reference to a provider of the aforesaid information technology solution; and (e) a date associated with the aforesaid information technology solution.

The aforesaid evaluation metadata may comprise at least one of: (a) the date of an evaluation for the aforesaid information technology solution; (b) a description of a goal of the aforesaid information technology solution; and (c) a reference to user roles for the aforesaid information technology solution.

The invention further broadly and generally provides a method of storing a complexity evaluation of information technology management activities associated with an information technology solution, comprising: (a) identifying an information technology solution; (b) choosing an information technology management activity associated with the aforesaid information technology solution; (c) preparing a first complexity evaluation of the aforesaid information technology management activity; (d) capturing solution metadata regarding the aforesaid information technology solution; (e) capturing evaluation metadata regarding the aforesaid first complexity evaluation; and (f) storing the aforesaid first complexity evaluation, the aforesaid evaluation metadata, and the aforesaid solution metadata in a database. Some embodiments may benefit from additionally comparing the aforesaid first complexity evaluation with a second complexity evaluation.

The invention further broadly and generally provides a method for reporting comparative complexity of information technology systems, the method comprising: (a) selecting a first complexity evaluation from a database; and (b) preparing a report comparing the aforesaid first complexity evaluation with at least one additional complexity evaluation selected from the aforesaid database. This method may further comprise communicating at least a portion of the aforesaid report to a customer. Some embodiments may comprise: (a) selecting a set of complexity evaluations from the aforesaid database; and (b) preparing a report, the aforesaid report comparing aggregate complexity scores of the aforesaid set of complexity evaluations. Some methods in accordance with the present invention may comprise collecting reporting criteria from a customer. Additionally, the aforesaid reporting criteria may be encapsulated by stored metadata.

The invention further broadly and generally provides a system for quantitatively and comparatively evaluating system activity complexity, the aforesaid system comprising: (a) a database for holding complexity evaluations; (b) a comparator for communicating with the aforesaid database and comparing the aforesaid complexity evaluations; and (c) a reporter for reporting results of at least one comparison performed by the aforesaid comparator.

### BRIEF DESCRIPTION OF THE DRAWINGS

FIG. 1 is a flow diagram illustrating the steps and components of capturing IT management activity complexity evaluations and storing them into a database, according to an embodiment of the invention.

FIG. 2 is a flow diagram illustrating providing a service to select and comparatively report on IT management activity complexity evaluations, according to an embodiment of the invention.

FIG. 3 is a table illustrating a comparative IT management activity complexity report, according to an embodiment of the invention.

FIG. 4 illustrates a textual representation of such a report of the comparison of complexity of IT management activities according to an embodiment of the invention.

### DETAILED DESCRIPTION OF PREFERRED EMBODIMENT

The present invention provides techniques for performing the service of comparatively evaluating the complexity of IT management activities associated with technology solutions.

By way of example, in one aspect of the invention, a technique for providing the service of comparatively evaluating the complexity of IT management activities comprises the following steps/operations. At least one candidate technology solution is identified and meta data regarding the candidate solutions such as name, provider, goal, user roles, business purpose, price, date, and other attributes are entered into a database. The complexity of IT management activities associated with each technology solution under evaluation is discovered and quantified utilizing available techniques such as those taught in U.S. patent application Ser. No. 11/205,972 filed on Aug. 17, 2005. The quantified complexities of the IT management activities under evaluation are stored in a database for subsequent retrieval and reporting, and are associated with the appropriate respective meta data entries in the database. Comparative reporting is performed by receiving a customer communication requesting a comparative report for technology solutions and that meet specific criteria which are used to select a set of technology solution complexity evaluations from the database, and preparing reports containing relative as well as absolute complexity.

The step/operation of selecting a set of technology solution complexity evaluations may comprise selecting technology solution evaluations based on business purpose, price, provider, or any of the various attributes, alone or in combination, which were collected as meta data, associated with the individual solution evaluations, and stored in the database in the preceding steps.

The step/operation of reporting the comparative complexity of the IT management activities under evaluation further may comprise reporting results of the complexity analysis in one or more of a human-readable format and a machine-readable format.

Further, the step/operation of reporting the complexities of the IT management activities under evaluation may further comprise producing a report comparing such complexity in one of a variety of dimensions, including but not limited to aggregate complexity, parameter complexity, execution complexity, and memory complexity. Still further, the step/operation of reporting the IT management activity complexities of the systems under evaluation may further comprise producing a report via an algorithm that computes a relative financial impact of a specified configuration process.

Advantageously, the steps/operation of the invention may be useable to enable prospective purchasers of computing systems to help assess the relative costs of competing technologies. They may also be useable to help developers of technology to improve their products.

As will be illustratively described below, principles of the present invention provide techniques for providing a service of comparatively quantitatively evaluating the complexity of IT management activities. By way of example, one such IT management activity might consist of configuring a computing system. Configuring a computer system may encompass any process via which any of the system's structure, component inventory, topology, or operational parameters are persistently modified by a human operator or system administrator. Examples include, but are not limited to, installing, provisioning, upgrading, or decommissioning software or hardware; adjusting settings on two or more systems so that they are able to communicate with each other; adjusting system parameters to alter system performance or availability; and repairing damage to a system's state resulting from a security incident or component failure.

IT management activity complexity refers to the degree of simplicity or difficulty perceived by human operators, system administrators, or users who attempt to perform IT management tasks associated with a technology solution. Examples of IT management activities include, but are not limited to system installation, system configuration, release management, change management, problem management, security management, capacity management, and availability management. Quantification of a computer system's IT management activity complexity is useful across a broad set of computing-related disciplines including, but not limited to, computing system architecture, design, and implementation; implementation of automated system management; packaging and pricing of computing-related services such as outsourcing services; product selection; sales and marketing; and development of system operations/administration training programs.

Principles of the present invention provide a system and methods for producing a standard, reproducible comparative evaluation of the complexity of IT management activities. Note that we illustratively define a system's configuration as all state, parameter settings, options, and controls that affect the behavior, functionality, performance, and non-functional attributes of a computing system. We also illustratively define IT management activity complexity as the degree of simplicity or difficulty perceived by human operators, system administrators, users, or automated tools that attempt to install, configure, address problems, and otherwise manage the Information Technology aspects of a technical solution to achieve specific IT management goals.

Furthermore, principles of the present invention address the problem of objectively and reproducibly quantifying comparative IT management activity complexity of computing systems, which has not been done previously in the domain of distributed and enterprise computing systems. In accordance with illustrative embodiments, a system and methods are provided for solving the above problem based on a benchmarking perspective, which provides quantitative, reproducible, objective results that can be compared across systems, all at a low operational cost. We propose illustrative methods for collecting IT management activity-related data from a computing system that enable the quantification of such activity complexity in an objective, reproducible, low cost manner.

As will be further described below in detail, an illustrative architecture of the invention includes a metadata collector, a complexity data collector, a selection criteria collector, a complexity analyzer, a database, a comparative analyzer, and a reporter, each corresponding to a phase in the overall process of quantifying the complexity of IT management activities associated with a technical solution. It is to be understood that while each of these phases are described below as discrete phases, the various phases can potentially overlap (e.g., a continuous system that collects new configuration-related data while analyzing older data).

In a first data collection phase, one or more solutions to be evaluated are identified and specific IT management activities associated with said solutions are chosen for complexity evaluation. Meta data regarding both the solutions and the evaluations are captured and stored in a database. Solution meta data includes information regarding the solutions to be evaluated. Examples of solution meta data may include, but are not limited to, solution name, provider, version, price, business need which the target system fulfills, and system requirements. Evaluation meta data includes information regarding the evaluations conducted. Examples of evaluation meta data may include, but are not limited to, date of evaluation, scenario goals, and user roles to be examined.

For purposes of illustration only, the IBM data base product DB2 may be identified as a technical solution of interest. The IT management activity of configuring the database solution could be chosen for complexity evaluation. Solution meta data might include “Relational Database”, “IBM”, “DB2” “version 8.2” thus capturing the business purpose, vendor, name, and version of the technical solution whose IT management activities will be evaluated. Evaluation meta data might include “Configuration”, “dbadmin” “Apr. 1, 2006”, “minimal footprint”, “Linux”, thereby capturing the IT management activity to be evaluated for complexity, the role of associated human administrators, the date of evaluation, the goal of the configuration activity, and requirements or constraints of the activity.

In a further illustrative example, the Oracle database product Oracle may be identified as a technical solution of interest. The IT management activity of configuring the database solution could be chosen for complexity evaluation. Solution meta data might include “Relational Database”, “Oracle Corp.”, “Oracle” “version 9” thus capturing the business purpose, vendor, name, and version of the technical solution whose IT management activities will be evaluated. Evaluation meta data might include “Configuration”, “dbadmin” “Apr. 1, 2006”, “minimal footprint”, “Linux”, thereby capturing the IT management activity to be evaluated for complexity, the role of associated human administrators, the date of evaluation, the goal of the configuration activity, and requirements or constraints of the activity.

Further, in the data collection and evaluation phase, IT management activity related data is collected and evaluated utilizing any of a number of available techniques such as those taught in U.S. patent application Ser. No. 11/205,972 filed on Aug. 17, 2005. The results of the evaluation are then stored in a database and associated with meta data pertaining to the appropriate system under test, also stored in a database as previously described.

Finally, a last phase in the configuration complexity evaluation process involves the reporter component of the system. This component enables service customers to enter requests for comparative configuration complexity reports, comprises selecting those systems under test which meet any of a number of criteria which can be ascertained from examination of meta data stored in the database, prepares a report comparing the configuration complexity of the respective selected systems under test and communicates said report back to the customer. It will be appreciated by those skilled in the art that communications with the customer may take many forms including but not limited to telephone conversations, electronic mail exchanges, traditional mail exchanges, and internet browser facilitated exchanges such as Web Services enabled transactions.

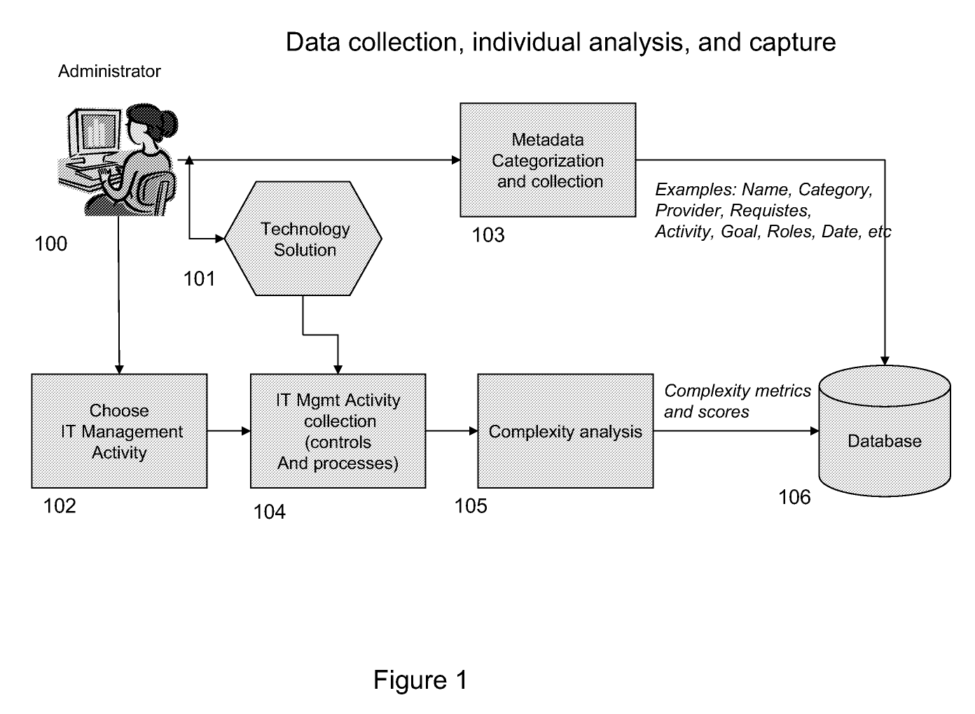

Referring initially to FIG. 1, a flow diagram illustrates the first stage of providing a comparative configuration complexity evaluation service and its associated environment, according to an embodiment of the invention.

As depicted, administrator 100 identifies a candidate technology solution 101 whose IT management activities are to be evaluated. The technology solution comprises the hardware components and software components that make up the computing system. Administrator 100 further chooses at least one IT management activity 101 associated with the candidate technology solution. This IT management activity will be the subject of the complexity evaluation. The technology solution under evaluation is configured and maintained by its human administration staff 100, comprising one or more human operators/administrators or users operating in an administrative capacity.

Meta data collector 103 is used by human administration staff to enter and store solution and evaluation meta data into database 106. IT management activity data collection 104 is performed by a procedure utilizing any of a number of available techniques, such as those taught by U.S. patent application Ser. No. 11/205,972 filed on Aug. 17, 2005 to generate a set of collected data. The collected data is consumed by complexity analyzer 105, which also utilizes available techniques such as those taught by U.S. patent application Ser. No. 11/205,972 filed on Aug. 17, 2005 to derive a set of low-level configuration complexity measures through analysis of the configuration-related data. The metrics and scores produced by the complexity analyzer are associated with meta data regarding the appropriate system under test collected by metadata collector 103 and stored in database 106.

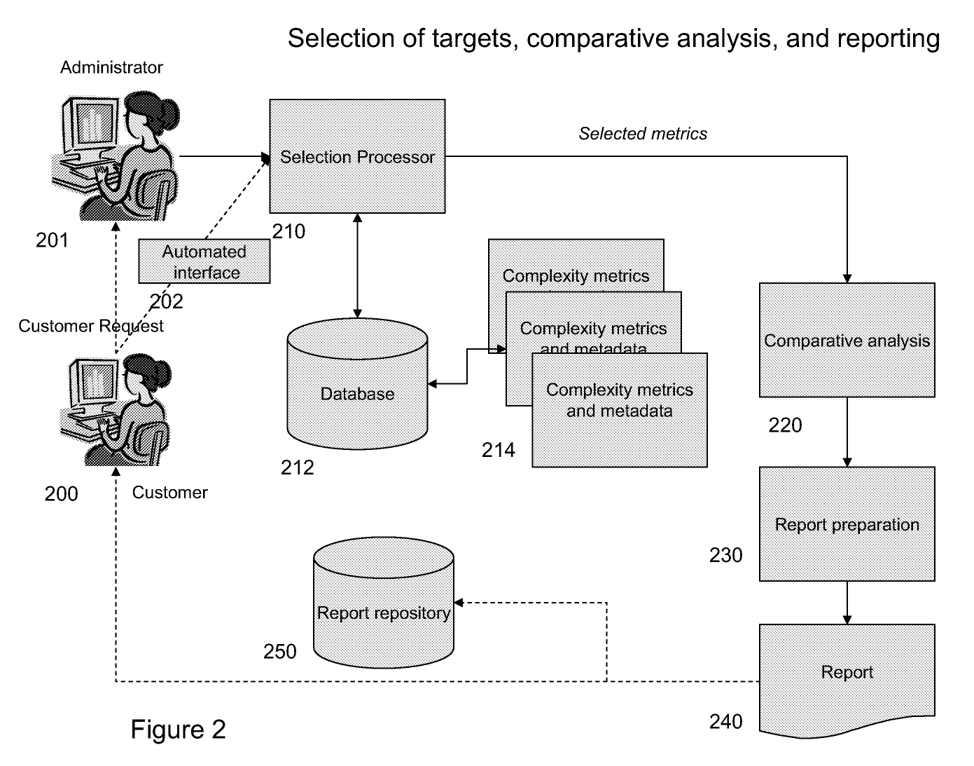

Referring now to FIG. 2, a flow diagram illustrates the phase of selecting a set of technology solution complexity evaluation metrics meeting criteria supplied by the customer and/or administrator and comparatively reporting on the metrics. Customer 200 communicates a request for a comparative complexity report to the comparative complexity evaluation human service provider interface 201 and/or automated service provider interface 202. This communication may take many forms, including but not limited to, written requests, telephone requests, electronic mail requests, subscriptions for periodic delivery of the reporting service, and World Wide Web-enabled requests.

Criteria for the selection of items to comparatively report on are collected by Selection processor 210. Selection processor 210 interrogates the database 212 using the collected criteria and extracts appropriate complexity metrics and metadata 214 to be used in the comparative analysis and report preparation.

Control is then passed to Comparative Analyzer 220 which examines complexity metrics 214 and ranks metrics instances, representative of complexity evaluations of IT management activities associated with technology solutions, against each other. Rankings, metrics, and metadata are input to Report Preparation 230 which generates a comparative report. Such comparative report may represent data in textual form, graphical form, or a combination of both textual and graphical form. Comparative report 240 may optionally be stored in Report Repository 250. Comparative report may optionally be communicated to Customer 200 by any of a variety of means including, but not limited to electronic transmission, electronic file transfer, printed report, local display, portable storage media such as CD, diskette, and UBS enabled storage device.

As an illustrative example, a customer might navigate to a service provider's web site, open a web page which prompts the customer for selection criteria for comparative report generation. The customer might then enter the business purpose criteria of “Relational Database” and an IT management activity of “Configuration”. These criteria are communicated to Selection processor 210 which formulates a query for all complexity evaluations whose solution metadata contains a business purpose of “Relational Database” and whose evaluation meta contains an IT management activity name of “Configuration”. Continuing the illustrative example described regarding FIG. 1, the complexity evaluations of the configuration of DB2 and of Oracle will be extracted, compared, a report generated in the form of a web page showing the relative complexity of configuring DB2 versus Oracle in graphic form which might then be presented to the customer.

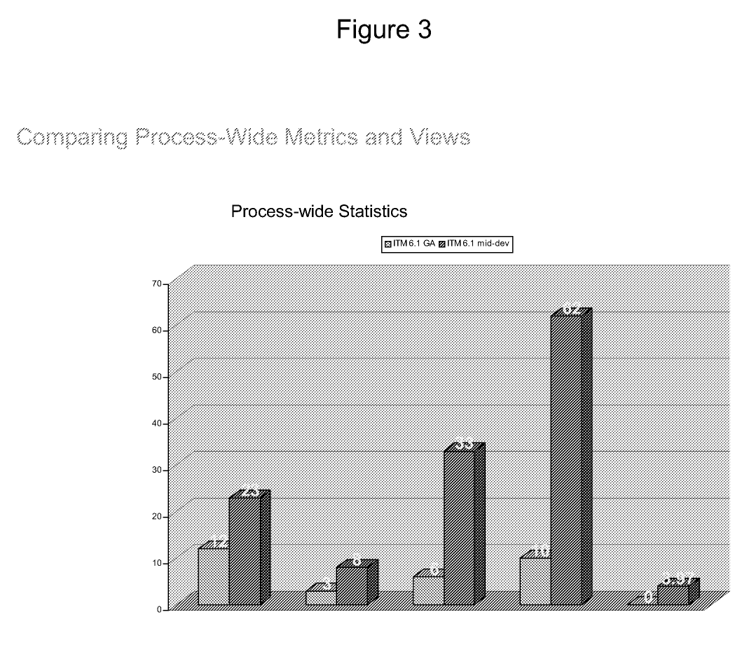

FIG. 3 illustrates a graphical representation of such a report of the comparison of complexity of IT management activities associated with internal versions of IBM products.

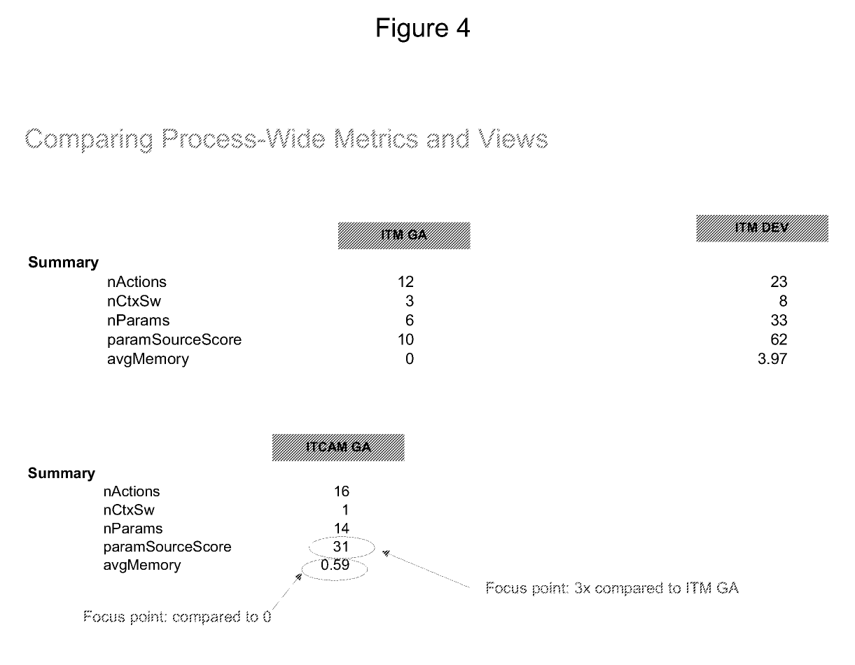

FIG. 4 illustrates a textual representation of such a report of the comparison of complexity of IT management activities associated with internal versions of IBM products.

It will be appreciated by those skilled in the art that Customer 200 could include internal as well as external customers. For example customer 200 could be an employee of the comparative evaluation service provider whose responsibility is to pre-package comparative complexity evaluation reports, and potentially to populate a catalog of such reports from which external customers could choose.

Accordingly, as illustratively explained above, embodiments of the invention describe a service providing comparative, reproducible evaluation of the complexity of technology solutions. The methods may advantageously include techniques for collection of metadata regarding both the solutions and evaluations, conducting complexity evaluations of specific IT management activities associated with technology solutions utilizing available methods such as those described in U.S. patent application Ser. No. 11/205,972 filed on Aug. 17, 2005, collection of selection criteria for purposes of comparison, comparative analysis, and reporting of such selected comparative IT management activity complexities. The system may advantageously include a collector of solution and evaluation meta data, a complexity data collector, a database, a complexity analyzer, a selection criteria collector, a comparative analyzer, and a reporter. The collector of solution and evaluation meta data will collect information regarding technology solutions and the complexity evaluations of specific IT management activities associated with the solutions and store the meta data in a database. The complexity data collector may gather IT management activity information from traces of actual technology solution processes or from the set of exposed controls on a technical solution. The complexity analyzer may use the collected IT management activity data to compute quantitative measures of low-level aspects of IT management activity complexity as well as high-level predictions of human-perceived complexity and will store such quantitative measures and predictions in a database. The selection criteria collector will extract desired previously collected complexity metrics from the database. The comparative analyzer will rate the comparative complexity of IT management activities associated with selected technology solutions. Finally, the reporter may produce human-readable and machine-readable comparative reports of the complexity of IT management activities associated with selected technology solutions.

Furthermore, while the illustrative embodiments above describe performance of steps/operations of the invention being performed in an automated manner, the invention is not so limited. That is, by way of further example, collecting technology solution data, analyzing such data, and reporting complexity may be performed entirely manually, or with a mix of manual activities, automation, and computer-based tools (such as using spreadsheets for the analysis or manually collecting IT management activity data and feeding it to an automated comparative complexity analyzer ).

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A database comprising at least one record, said at least one record comprising:
(a) solution metadata relating to an information technology solution; and
(b) evaluation metadata relating to a complexity evaluation of said information technology solution.

2. A database as set forth in claim 1, wherein said solution metadata comprises at least one of:
(a) an identifier for said information technology solution;
(b) a description of the purpose of said information technology solution;
(c) the price of said information technology solution;
(d) a reference to a provider of said information technology solution; and
(e) a date associated with said information technology solution.

3. A database as set forth in claim 1, wherein said evaluation metadata comprises at least one of:
(a) the date of an evaluation for said information technology solution;
(b) a description of a goal of said information technology solution; and
(c) a reference to user roles for said information technology solution.

4. A method of storing a complexity evaluation of information technology management activities associated with an information technology solution, comprising:
(a) identifying an information technology solution;
(b) choosing an information technology management activity associated with said information technology solution;
(c) preparing a first complexity evaluation of said information technology management activity;
(d) capturing solution metadata regarding said information technology solution;
(e) capturing evaluation metadata regarding said first complexity evaluation; and
(f) storing said first complexity evaluation, said evaluation metadata, and said solution metadata in a database.

5. A method as set forth in claim 4, further comprising comparing said first complexity evaluation with a second complexity evaluation.

6. A method for reporting comparative complexity of information technology systems, the method comprising:
(a) selecting a first complexity evaluation from a database; and
(b) preparing a report comparing said first complexity evaluation with at least one additional complexity evaluation selected from said database.

7. A method as set forth in claim 6, further comprising communicating at least a portion of said report to a customer.

8. A method as set forth in claim 6, further comprising:
(a) selecting a set of complexity evaluations from said database; and
(b) preparing a report, said report comparing aggregate complexity scores of said set of complexity evaluations.

9. A method as set forth in claim 6, further comprising collecting reporting criteria from a customer.

10. A method as set forth in claim 9, wherein said reporting criteria is encapsulated by stored metadata.

11. A system for quantitatively and comparatively evaluating system activity complexity, said system comprising:
(a) a database for holding complexity evaluations;
(b) a comparator for communicating with said database and comparing said complexity evaluations; and
(c) a reporter for reporting results of at least one comparison performed by said comparator.

12. A program storage device readable by a digital processing apparatus and having a program of instructions which are tangibly embodied on the storage device and which are executable by the processing apparatus to perform a method of storing a complexity evaluation of information technology management activities associated with an information technology solution, said method comprising:
(a) identifying an information technology solution;
(b) choosing an information technology management activity associated with said information technology solution;
(c) preparing a first complexity evaluation of said information technology management activity;
(d) capturing solution metadata regarding said information technology solution;
(e) capturing evaluation metadata regarding said first complexity evaluation; and
(f) storing said first complexity evaluation, said evaluation metadata, and said solution metadata in a database.
